(19) United States
(12) Patent Application Publication
(10) Pub. No.: US 2008/0156705 A1
(43) Pub. Date: Jul. 3, 2008

(54) Computer Assisted Manual Sorting of Identification Coded Items

(76) Inventor: Herbert L. Markman, Wynnewood, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/966,058

(22) Filed: Dec. 28, 2007

Related U.S. Application Data
(60) Provisional application No. 60/882,384, filed on Dec. 28, 2006.

(51) Int. Cl. B07C 5/38

(52) U.S. Cl. 209/552

(57) ABSTRACT

Commingled items are sorted down into groupings, such as textile items that are associated with distinct clients and/or groups of related clients, by employing a programmed computer to manage sorting destinations at plural levels of sorting. An RFID reader coupled to the computer senses an item's identification code. A human sorter responds to signaling from the computer to move successive items to a destination or along a path that determines a preliminary grouping or sorting stage. The number of destination sort positions is limited to a manually-manageable number, and also can be varied under program control to exploit all the sorting positions provided at the final sort stage. Provisions are made to handle outlier items that become separated from other members of their groups. Automated order fulfillment scanning at a final stage ensures accurate sorting results.

### CROSS REFERENCE TO RELATED APPLICATION

This application claims the priority of U.S. Provisional Application Ser. No. 60/882,384, filed Dec. 28, 2006.

### BACKGROUND OF THE INVENTION

1. Field of the Invention

The invention concerns the sorting down of items that have been commingled, into groupings that are associated with distinct clients and/or groups of related clients. The items are encoded for automatic identification and are associated in a computer memory with particular clients and/or groups. The commingled items are separated into deliverable groupings by manual sorting steps supported by a computer process.

2. Prior Art

In operations that accept items from clients for processing, especially cleaning processes, it is usually impractical to handle each client's group of items as a separate unit through the process. It is more efficient to process commingled items from a number of clients together, and to sort the processed items afterwards to reassemble the items into the same groups, that are finally returned to the clients.

Therefore, incoming items collected from clients in groups, such as garments to be cleaned, are divided into processing categories, such as colored versus white textile materials (so that only white items are bleached) or cotton versus synthetics (to be treated at different temperatures or with different cleaning solutions), etc. The commingled items can be processed in high capacity industrial machines, which is efficient for processing reasons. However it is necessary after processing to sort the commingled items back into their original groups, so that the same items can be returned to the customers from whom the items were collected. In an industrial cleaning process, these requirements apply as well as other complications such as the need to adhere to a schedule of collection and delivery, the need to associate particular customers with pickup/delivery routes, etc.

The client or customer items need to be identified in a manner that survives processing, so that the same items can be identified with the associated clients when sorted from the commingled state back into the original groups. For this purpose the incoming items can be provided with a temporary or permanently affixed identifying indicia such as a printed label, a barcode or an electronically readable code device. It is particularly advantageous to use radio frequency identification (RFID) encoding tags that are clad to survive numerous cleaning cycles and are sewn into a seam or hem. Such tags can be read at a short distance, and do not require a direct line of sight, so that little or no human involvement is needed to automatically acquire the identity code carried on a tag. The most recent tags also can be discerned when in close proximity with other tags in a garment bundle, using so-called “multi-read” tags and readers.

Inasmuch as articles bear a code (whether RFID or otherwise), an inventory control system can maintain a database reflecting various fields of information. Without limitation, the database might include stored information identifying the wearer, the customer or client (such as the wearer's employer), a description and history of the item, the route and date of pickup and prospective delivery, etc. In different processes, more or less information might be stored. At least each article is identifiable from visible or electronic indicia, and the articles are identified at least in connection with assembling finished bundles to be returned to the user.

Available equipment for sorting may be automatic or may operate with human action. Automatic sorting equipment is quick and sure but is very expensive. Human sorting is relatively time consuming but requires only a subdivided collection zone such as a set of hanger locations at which items identified with a group can be assembled until the sorting is complete.

U.S. Pat. No. 5,794,213, which is incorporated by reference in its entirety, teaches a hybrid of automatic and human sorting wherein audible and/or visual signals are associated with a number of sorted item positions and are controlled by a processor coupled to a code reader. The processor obtains the code of an item presented during sorting and either assigns a sorting position to the group including that item, or determines that a position has already been assigned to that group because one or more members of the group has already passed. The processor triggers a signal identifying the sorting position and the human puts the item there. Preferably, the processor can determine how many items are associated with a group, e.g., from an inventory control system or perhaps from a code included on each item in the group, and counts to determine when the group is complete. A signal is operated to indicate that the group is complete and the sorting position is made available to be assigned as the collection point for members of a subsequent group.

In order to accommodate batch sorting workflow wherein items associated with a given grouping may extend over two or more batches sorted in succession, it is alternatively possible to sort to the end of a batch to be sorted, keeping aside items known to be part of a grouping that is not completed with the end of that batch. By providing for early items and straggler items in this way (namely regularly to handle items of a given grouping that precede or lag members of the same grouping that are encountered for sorting in a different sorting batch), overall efficiency is improved. Items are processed in batches leading up to batch sorts. A processing batch can be made up of two or more groupings and can be sorted as a unit. A large grouping can be divided into two or more processing batches. Defining a collection of combined or fractioned groupings as processing batches is useful to exploit substantially the full capacity of machines that operate on loads for processing, e.g., wash wheels or other machines, dryers and similar facilities. In this context, an exemplary grouping category that might be handled as a processing batch, advantageously an correspond to a category into which the items are ultimately sorted down, for example and without limitation, the contents collected on a delivery route, the contents collected on a given day or other time period, items associated with one pickup-deliver stop, or customer identity, etc.

A computer assisted sorting method and apparatus as described is almost as fast as a robotic sorter having diverters and conveyors with motors, solenoids, solenoid valves and the like controlled by a processor. But a manual computer-assisted sorting method is more versatile and less expensive, even when accounting for the wages and benefits paid to the human employee, than outfitting, operating and maintaining a fully automated robotic sorter. However there are limits. It is conceivable that an industrial laundry operation cyclically handling uniforms and the like might collect from ten to twenty route trucks. Each route might serve up to 50 stops in a cycle. Each stop might have any number of individual wearers who present one or several garments to be cycled through a cleaning process. Assuming that there are an average of 5 wearers per stop and three items per wearer, there would be 7,500 to 15,000 garment items, to be sorted into perhaps 5,000 bundles that must be associated with their respective routes, preferably in the order of their respective stops.

It is difficult or impossible to attempt to sort into a large number of sort destinations (e.g., bundles to be delivered to a given wearer of garments) at one time, whether by automatic means or manual means. Manual sorting to a given number of bundles requires that such number of bundle collection positions be within reach and quickly and easily found, which is difficult when thousands of bundles are to be sorted out. Assuming a robotic sort, it may be necessary either to define thousands of potential paths to discrete collection areas, or in the case of picking from a circulating conveyer, it may be necessary to circulate the conveyor numerous times past the items to be picked out during sorting for association with other members of the same grouping.

The present disclosure is characterized by sorting in successive stages, with reduces the number of collection positions needed. In a first stage, for example, the items might be sorted at least partly by reference to associated collection/delivery routes (requiring 10 to 20 preliminary collection areas in the above example). Next each sorted-out route is sorted again, for example by a subcategory such as a stop number (up to 50 collection areas in the example), or there are only a few stops with numerous wearers, one might sort by a low order digit of a code number (10 collection areas). In a third sorting operation, the items collected are sorted or re-ordered to put the items of the same wearer in physical proximity. This third sorting operation generally is typically done by shuffling the order of the items at collection zones instead of moving articles from a commingled collection rail or the like, selectively to the discrete collection zones where the members of associated groupings are accumulated with one another.

Human-controlled sorting requires time and attention. Human-controlled sorting requires a good deal of organization to optimize the situation for the numbers and ratios of items encountered in different groupings (e.g., the number of routes or stops on a route or customers, etc.). However, these numbers and ratios can be expected to change from time to time and to differ from one route to another. Thus, it might be possible to build a human assisted or even totally robotic sorting system having up to 5,000 bundle assembly positions. However, a human assisted system of that capacity would be impractical because so many assembly positions could not be put within easy access of a human sorter. In different situations, more or fewer of the positions would not be used.

A better organized human or robotic sorting system of comparable capacity can be arranged for sorting in stages. However where there are hierarchical associated groupings with different numbers of members involved (such as groupings with 5, 10, 20, 50, etc. sub-groupings, in the foregoing example), it is difficult to predict and arrange an optimal number (or at times a sufficient number) of collection points such as sorting rails or other assembly positions for successive stages of sorting, so that there are enough positions to accommodate the variations. What is needed is to provide a sufficient number sorting positions to handle the members of associated groups when sorted at one time, but not to provide so many that when handling a level with a large number of member categories (e.g., 50), many are not regularly used.

### SUMMARY OF THE INVENTION

It is an aspect of the invention to quickly and efficiently sort down items that have been commingled, into groupings that are associated with distinct clients and/or groups of related clients. The items are encoded for automatic identification and are associated with one another in a computer memory, especially by relating to the same routes, stops, customer, wearers, and/or other groups. The commingled items are separated into deliverable groupings by manual sorting steps supported by a computer process. As each encoded item is encountered, the process determines, and signals to a human sorter, a selected group or path (e.g., a collection rail) for use to accumulate the related items for that group or to move on that path. From these groupings, items are again sorted in one or more subsequent stages, down to a destination sort position where associated items ultimately are collected, e.g., for packaging and delivery.

There may be several stages of sorting possible to sort into route, stop, customer, wearer, etc. However, an advantageous object is to minimize the number of sorts needed, preferably to only two stages, while serving the interests of efficiency and practicality.

The number of final groups may be large, but the number of destination sort positions used at each stage is limited to a manually-manageable number. The number of positions can be varied under program control to use sort positions efficiently at each stage. According to one aspect, an earlier sort stage is managed so that the items grouped at the earlier stage into preliminary groups are associated in a number that will exploit most or all of the sort positions at a successive sort stage.

The items have automatically-sensed identification codes such as multi-read RFID tags. The sort position selected by the program can be signaled visually, audibly or otherwise. The items are sorted down, e.g., to unique wearers or customers in the case of cleaned garments, while being grouped together by delivery routes and/or customer locations. Although the number of sort positions is limited, provisions are made to handle outlier items when encountered separate from other members of their groups. An important object is to ensure accuracy of fulfillment of orders, for example to ensure that the content of an outgoing order of cleaned garments contains every last garment that was detected when incoming items were taken into inventory and “scanned in.” The present technique enables order fulfillment scanning at a final stage, using multi-read RFID tags to capture item identity data that is compared to a stored record of item identities, such as the identities of items that are scanned when received. Techniques are provided to ensure accuracy and to flag discrepancies should they arise.

The clients can be customers, such as the owners of items submitted for processing, for example items to be cleaned and sorted from the items of other customers for return to their owners. The sorting process is useful for cyclic collection processes such as the cleaning of uniforms and similar garments.

In addition to managing preliminary batching and initial sort stages via programming to combine subsets as logically appropriate sort groupings such as delivery routes, the size of successive sorting populations can be constrained using historically based predictions. By aiming to cause the final sort stage to exploit a full nominal sorting capacity that is available (a given number of destinations for sorted items), the sorting is managed efficiently to exploit such capacity.

Although numerous routes and customers can be serviced, the number of successive sorting stages in a cyclical batch cleaning process where incoming items collected from a given route proceed through the process more or less in order, generally can be limited to two sorting stages. The items to be sorted are presented in a sorting batch as a grouping.

Some items of input groupings (e.g., collection/delivery route groupings) are separated from other members of such a grouping into plural sorting batch groupings. Items encountered in sorting batches may lead or trail other members of their collection/delivery route, which will be encounter in later sorting batches (or already have been encountered in a previous sorting batch). Provisions are made to handle leading items and stragglers when encountered. Full order fulfillment is checked by multi-reading the items that are assembled into a sorted bundle or similar unit, that can be handled or marked appropriately if an item is missing, or if two or more smaller units, such as the garments of two different wearers, have been necessarily combined to deal with a situation wherein a sort stage has a larger number of member groupings than there are collection areas available to receive them.

An object of the present invention is to provide an efficient technique to organize a process to reduce the number of sorting stages required. According to one aspect, a process of sequentially processed batches is maintained, insofar as practical, in step with incoming grouped items. Thus, the collected items in each collection route (or other associated category) can be fed into the process one after another until the collected items are all in processing, before the next such category (a different collection route) is fed into processing. Where necessary for exploiting the capacity of processing machines, two collection routes (or more) that abut one another in the processing stream, may be combined during batch processing and commingled for handling as a group that will need to be sorted down later. A data processor is used to assist in controlling the number of streams to be sorted (e.g., the size of the population of potential wearers that will be sorted at one time).

According to another aspect, the number of wearers in the population, which is a variable, is predicted by the data processor from historical information. This information is used to plan sorting stages according to probability. A tradeoff is established between exploiting full processing capacity and maximizing sorting efficiency using a computer-assisted manual technique, such as that of U.S. Pat. No. 5,794,213, involving signaling a human sorter as to where to place each item that is presented in turn for sorting. However, the arrangement is controlled so that in a preliminary sort stage the items are presorted into rails or the like that each accumulate items of a predetermined number of wearers, and that number is complementary to the number of collection rails or the like in a subsequent stage sort, wherein computer-assisted manual sort also used. In one embodiment, only two stages of sorting are typically needed in a moderately sized industrial cleaning operation or the like.

The process preferably is operated in a manner that exploits the full processing capacity of industrial washers such as wash wheels, dryers, steam tunnels and press arrangements, but uses sequential serial processing and control of the size of the sorting population that is encountered for each successive sorting batch. Furthermore, during plural staged sorting operations, the technique at least substantially conforms the population being sorted using a variable number of sort positions or destinations on the first stage (the positions being sometimes termed sorting “rails” herein), so as to improve the probability that the number of sorted units needed when sorting out of those rails into destinations at a subsequent stage, is a number that is equal or nearly equal to the number of final sort stage collection sites that are available, e.g., about 24 in one embodiment. The final number of sort stage collection sites is chosen as a number that is easily accessible to a manual human sorter, given the size of the articles, the range of mobility and reach of the operator in the particular facility and similar factors.

The human sorter reacts to prompting from a computer system coupled to a reader that automatically captures the ID code of a garment destined for a sorting site and identifies the site by audible signal, a display screen indicia, a signal light or buzzer, etc.

Another object is to adapt the process to diverse situations, for example when the population of wearers for a route or customer is unusual or when selected collection units are small and might be combined into a limited population batch (such as the garments of two or three discrete routes) to make up a full processing load from two or more limited population batches that would otherwise be processed successively. Provision is made for “early” items whose counterparts are mostly found in a subsequent batch, or “late” straggler items that are stragglers that could not stay with counterparts associated for the most part with a preceding batch.

Another inventive technique is to predict, optionally at least partly from historical data, the number of wearers that will be found in a batch and to arrange sorting breaks of finished batches into collection rail groups during a first stage sort. The system seeks to make the number of wearers expected on each collection rail equal to the optimal number of wearers to be segregated in the next stage, which preferably is the final stage sort. Whereas this division is based on probability, an associated object is to adapt to situations in which the actual population unpredictably differs from the projected population, especially to enable the system and the sorter to deal with a situation wherein there happen to be more wearers than sorting destination locations.

For example, a conveniently manually accessible number of sorting rails is provided for first stage sorting of a batch. The batching is planned such that there is a favorable probability of a given number of wearers' garments to be sorted onto the rails when sorting in a first output sort level. In one embodiment, 24 wearers per collection rail could be is the target for the first stage sort. In this disclosure, 24 is used to exemplify a convenient number of distinct destination collection positions or rails or pathways or the like when sorting from one to “n” groups (n=24). It should be appreciated that a smaller number might be used, e.g., as few as six, or a larger number, e.g., up to 36 or more. It is generally comfortable for a sorter to access from 10 to 32 output positions fed from one or more input paths. According to one aspect of the invention, the number of sorting rails used is made variable, so that all or nearly all of the final sort sites are efficiently used.

When sorting in a second and final stage sort (preferably using the computer assisted sorting technique of U.S. Pat. No. 5,794,213), the computer processor can be arranged to operate lights or data displays, play out an audible message or otherwise direct the sorter to place each next item at one of a convenient number of sorting destinations (e.g., enough for 24 wearers) corresponding to a convenient number of human-sorter-accessible collection positions. The inventive technique substitutes batching for one of the three sorting stages that would be required in a conventional sorting system. The inventive technique also is tolerant of variations in the size of groups (e.g., number of wearers, number of route/stops) in a way that aims for the final sort to provide optimal efficiency by full use of the available final sort bundle assembly positions.

The target of 24 wearers per collection rail is not always realized. In a manner similar to handling “early” and “late” batch members, the inventive method accommodates variations that occur in ratios among the numbers of wearers, customers, stops, routes, days and so forth. If for example, sorting the batch to all the collection rails would likely produce fewer than the optimal 24 (or other) number corresponding to the number of final sort positions, the system reduces the number of collection rails used, and in this way forces the number of wearers per rail to increase, preferably at least to approach the optimal number equal to the number of final sort positions. If notwithstanding predictions, the sorting puts more than 24 wearers on one rail, the computer assisted sorting processor reacts by assigning at least two wearers to at least one final sort position, and generating a label that marks that position as needing further attention to subdivide the bundle into discrete wearers.

A further object is to test the final bundles to resolve that all the garments that were brought into the plant also go out. In a preferred arrangement comprising multi-read tags, RFID codes in final bundles are compared to a target inventory to ensure that what comes in also goes out. The target might be determined at various points, such as when collected by the route operator or when associated in batches before processing or when emerging clean. Preferably the target is determined at the earliest point that the garment ID tags are detected, and compared to the bundle contents at a point at the end of the process, which correspond to a change of custody or other pertinent inventory state.

The disclosed process forms batches by associating a variable number of related articles to process optimally full size processing batches. The process then uses a first stage sort (from the output of the cleaning process to collection rails) that has a variable number of collection paths (e.g., rails) that are arranged insofar as possible to have the optimal number of wearers in each path or rails that is equal or nearly equal to the number of final stage bundle collection points (e.g., n=24). At the final stage, excess wearers are combined and multiple wearer bundles are marked for division. The output is finally inventoried and the bundles proceed once more to be delivered to, used by and returned from the wearers in the field.

### BRIEF DESCRIPTION OF THE DRAWINGS

There are shown in the drawings certain embodiments of the invention as presently preferred. It should be understood that the invention is capable of embodiment in a range of possible embodiments that may be more or less complicated, secure or otherwise variable in ways discussed. The invention is applicable to all such variations. In the drawings,

FIG. 1 is a schematic floor layout of the finishing area of an industrial cleaning facility, in particular showing where two levels of sorting are conducted according to the invention in a manner substantially eliminating the need for a third sort.

FIG. 2 is a flow chart demonstrating certain data processing steps.

FIGS. 3 through 6 show certain screen captures associated with grouping of batches prior to processing (washing, drying, steaming/pressing).

FIG. 7 is a schematic view showing workflow.

### DETAILED DESCRIPTION OF PREFERRED EMBODIMENTS

The present disclosure provides methods and apparatus that enhance the efficiency and speed of sorting in an industrial laundry or similar process in which articles such as garments or other textiles are to be sorted down into individual customer orders from a commingled state in which a previous physical association of the articles may have been lost by processing together. Thus, a number of articles from plural wearers or similar groupings are to be sorted into bundles or other groupings that each can include one or a number of individual articles that are associated with one another, such as the articles of a particular wearer employed by a customer of the laundry at a particular stop along a route.

According to one aspect, preliminary steps are taken to collect associated incoming groupings into processing batches, wherein each processing batch size is at or near the optimally efficient processing capacity for batches. While generally preferring a first-in-first-out (FIFO) order, a preliminary operational step therefore is to combine incoming groupings in a sequence that may alter their FIFO order, to at least approximate optimal batch size.

Combining incoming groupings (such as the incoming contents of discrete collection routes) into batches preferably combines discrete full collection groupings into batches such that a particular collection unit does not overlap and fall into two or more batches. At times, an overlap is unavoidable, for example if an incoming collection grouping is larger than the optimal batch size. This can be accommodated by permitting “early” items that emerge with a first batch to be held over for completion of sorting when the remaining contents of the associated group arrive in the next or a following batch. Similarly, “late” items are held over for sorting with a following batch if upon completion of a batch, their particular customer order or bundle has not accumulated all the articles to be included.

The process is carried out on a straight-through batch basis insofar as possible. It is also possible to have diversions that rejoin the stream of articles during or after sorting phases wherein the customer orders are assembled (typically being the re-assembly of the same collections of items that were obtained from the customer and are to be processed and returned). Thus, for example, a straight through process for uniforms may involve inspection and sorting by category such as garment type, fabric, color or other aspect, followed by washing together with other articles of the same category, drying, pressing or steam treatment, folding and/or hanging and packaging, an finally, reassembly and delivery on the same collection route.

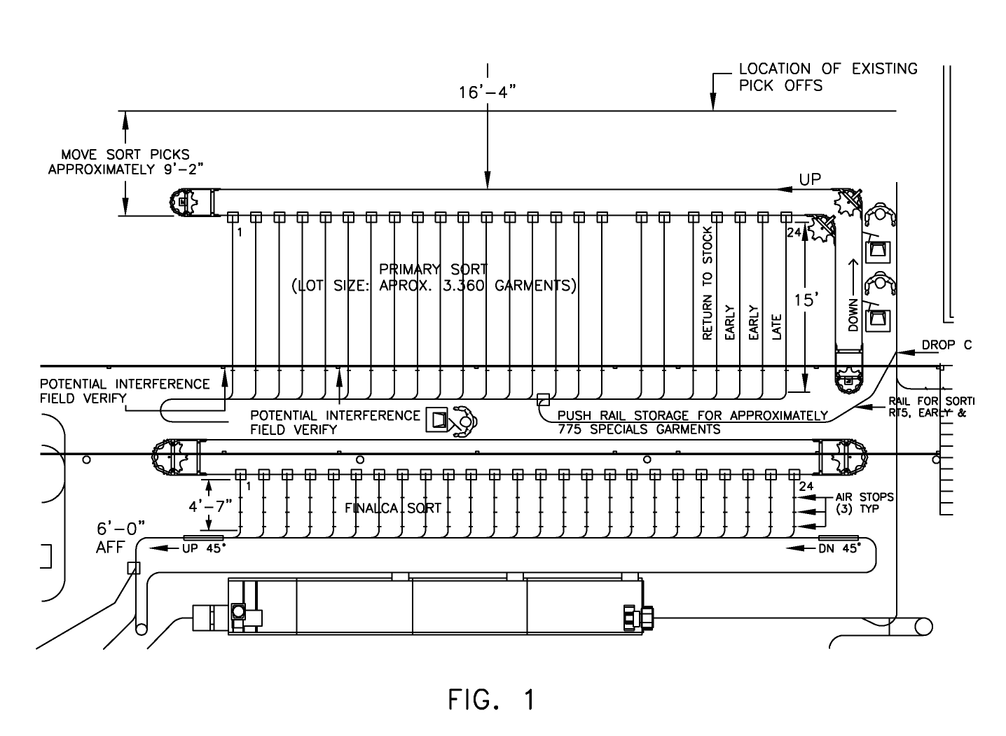

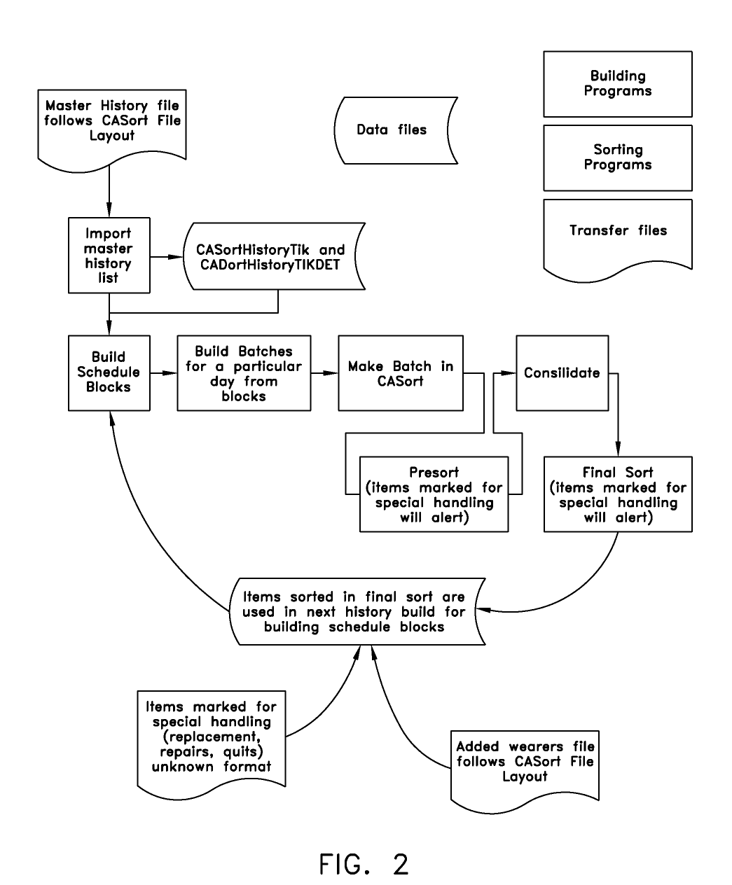

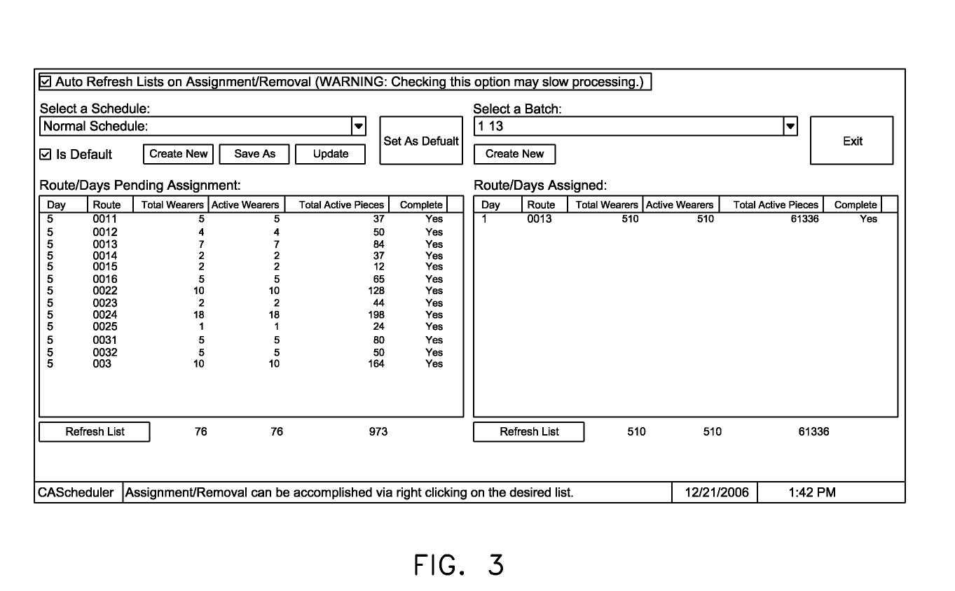

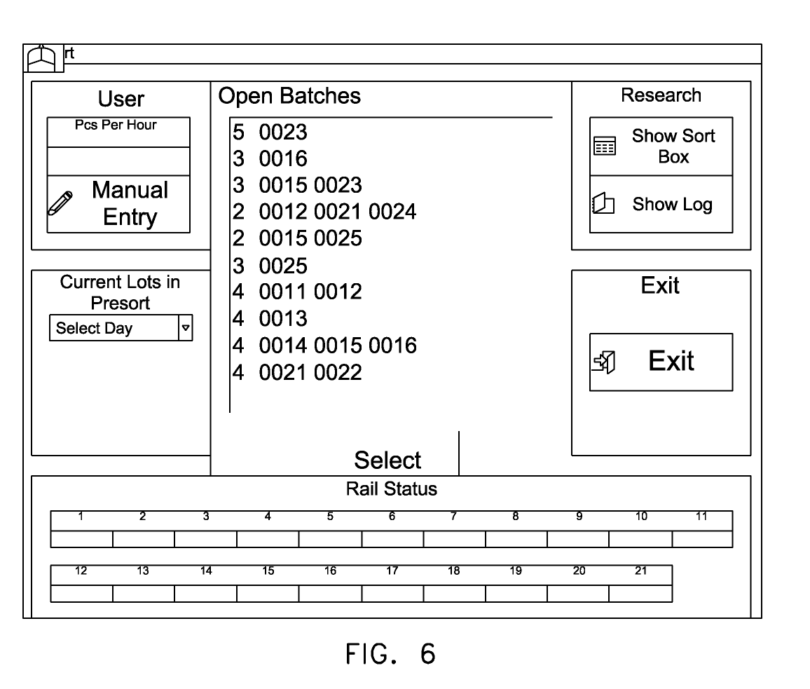

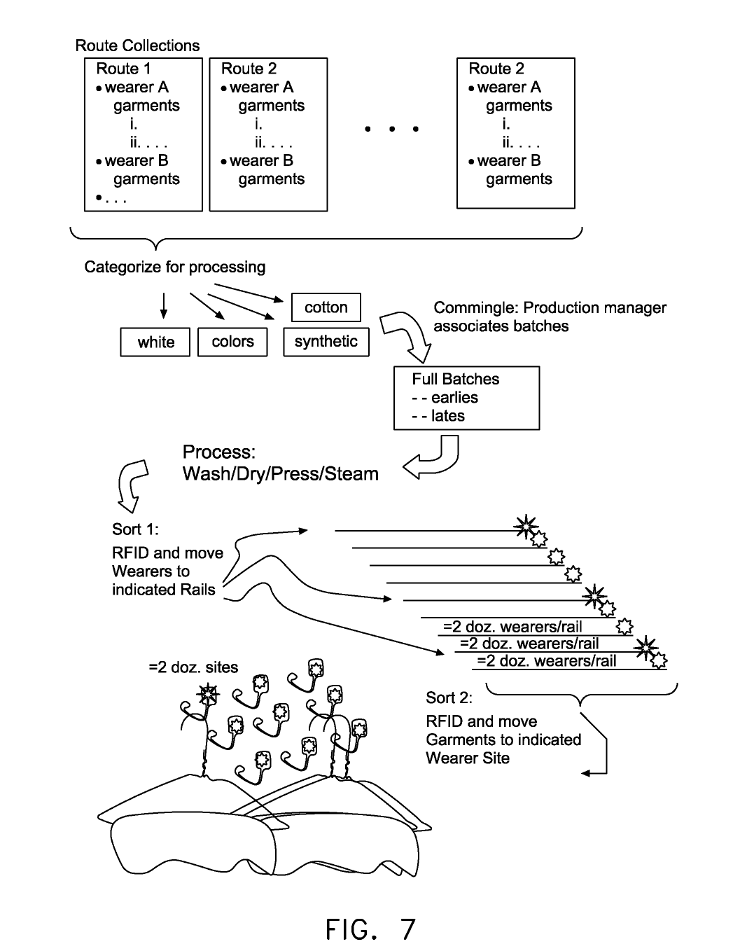

FIG. 1 is a floor plan showing the finishing area of a cleaning plant installation, namely where commingled items are sorted back into their initial groupings (e.g., customer orders), separated special items such as repaired garments are rejoined, the groupings are associated with routes for delivery, and the integrity of the outgoing bundle contents is finally checked and verified. The process flow is generally as shown in FIG. 7. FIG. 2 illustrates processing steps associated with setting up batches from incoming routes, and assigning selected groups of wearers to initial sort rail. FIGS. 3-6 are screen captures showing how user selections are used. The system employs automation and human user planning and execution in conjunction with one another, to make optimal use of sorting resources.

The disclosed process generally accepts articles that arrive in sequential groups, such as the soiled garments collected from two or more collection routes. Normally, individual garment wearers contribute only to one collection route. Therefore, one way to limit the number of wearers whose garments are to be sorted after commingling would be to process only one route at a time. However, the washing, drying and other apparatus (not shown in FIG. 1) may have a capacity equal to the collections of two or more routes, such that two or more routes are processed in one batch.

Nevertheless, one aim is to commingle a minimum number of routes in a batch while processing batches through, including through sorting, one after another. This controls the size of the population of wearers (or customers or stops, etc.) that are encountered during sorting stages. Another aim is to provide batches that fill the available capacity of the washers, dryers and steamers for processing.

An important aim is to organize the second-last sort step so that the following final sort step feed only into a predetermined manageable number of article accumulation stations. That is, the process aims to handle only a predetermined manageable number of wearers in the articles that are being sorted at the same time. The particular number can vary somewhat, but could be, for example, about two dozen. Therefore, a human-assistant can be readily cued by a processor coupled to an RFID code reader that identifies a given destination for each article presented, by reference to a data memory that cross references the RFID codes to groups (and optionally other inventory control information). The number is such that all of the potential destinations are within reasonable reach and access of the computer assisted human sorting operator.

The disclosed embodiments can be operated to exploit the full capacity of available garment processing facilities. These embodiments also exploit the available conveyors and sorting facilities. However, insofar as there are at least two stages of ultimate sorting, those stages are not both operated at capacity. Instead, the first stage is operated in a planned way to provide subsets of garments to be sorted in the final step, wherein each subset has a number of wearers included in the subset, which number encompasses all or almost all of the capacity of the final sorting step (i.e., uses most or all of the available sorting positions).

The invention performs at a comparable speed but involves a lower expense than complex and expensive fully automated sorting equipment with automatic conveyer diverters and similar computer controlled actuators. Further, the invention can be applied to laundry facilities that were formerly used with totally manual sorting, with minimal additional expense and disruption.

Garments are picked up by truck, typically by a route operator who visits a number of customer locations, each of which contracts for the cleaning of garments of a number of workers. A typical application is uniforms. The garments are collected and brought back to the industrial laundry for processing which includes washing-drying-steam tunnel or pressing and mending and assembly back in the same groups as collected (or at least are directed to the correct wearer). When the garments are unloaded from the delivery truck they need to be sorted into soil categories that are appropriate for the same processing. Therefore, incoming bundles from wearers are broken apart by garment category. Examples are whites versus colors, cotton versus synthetic, steam versus press and so forth. At this point, the garments of plural wearers are intermixed. At the end of the process, the wearers' garments need to be reassembled so that the processed garments can be returned to the same wearers.

In some arrangements, the garments that are picked up on the collection route are exchanged directly for clean garments. If so, the processed garments that are being returned might be ordered not only by the wearer and the collection route, but also by a delivery day. In order to facilitate a cyclic operation, it is advantageous to maintain some grouping of garments thru the plant, at least by route. Depending on the size of the route and the size of the wash wheels in the washroom, from one to “X” routes might be carried through the process together as a batch that will eventually need to be sorted to reassemble the customer orders.

After processing, the garments from a batch are subjected to an initial sorting stage. This stage is preferably computer-assisted as in U.S. Pat. No. 5,794,213, but is limited to subdividing the whole population of wearers from a batch into sorting sets that each include the number of wearers to be discriminated in the final sorting step. Preferably, collection rails are provided in an arbitrary number that is conveniently accessible by the computer assisted human sorter. Each rail accumulates the garments of a second number of wearers equal to the number of conveniently accessible final sort positions, e.g., about two dozen. However if a batch occurs where there are fewer total wearers, the number of preliminary sort positions (rails) can be reduced so that the final sort positions are all used, rather than vice versa.

It is a goal to fill the wash wheels to capacity, for efficient energy and water usage. If associated garments of discrete routes are carried through sequentially and the wash wheels are filled to capacity in batches processed one after another in succession, then garments at the leading and/or trailing edges of the route-associated garments may become separated from other members of that route, when intermixed with other garments in the batch. The downstream sorting system needs to accommodate this event. This is done in the system by reserving some first level sort rails as “early” and/or “late” rails, namely rails that hold over the garments of some of the wearers and bridge between successive sorting batches, because such wearers may also have garments in a following processing and/or sorting batch.

Industrial laundries often have conventional hook conveyors, for example as manufactured for some years by conveyor companies such as White and Speed Check. These sorting systems are widely available in existing laundries and can be adapted to practice the present invention. Such hook conveyors may have from to 10 to 32 hooks that are numbered. The employees use the hook positions as distinct destinations or paths or sorting locations for garments when seeking to manually sort garments into groups.

Conventionally, wholly manual sorting takes at least three steps to sort garments manually into unique-wearer groups. The first sort typically is by collection/delivery route. The second sort is to divide the wearers of each route, which might number in the hundreds, into more manageable subsets for sorting down to ultimate bundles in order of route/stop/wearer. The garments can be grouped, for example, in subsets that each have 10 accounts (wearers), based on a certain digit or digits (e.g., a low order digit or digits) of the account number shown on a label. The garments alternatively can be separated by the stop number along the route. This is intended to reduce the number of wearers in each sorted population to a manageable number.

Once the population is reduced, the final wholly manual step is to shuffle the order of garments by moving hangers on each sorting rail until the garments are in wearer order. As a result of this shuffling of order, the garments of each wearer abut the other garments of that wearer on the rail. This shuffling requires some sort of human readable label on each garment with enough information to perform the sorting process down to the level of the wearer (e.g., a name and account number).

According to an inventive aspect, the present embodiments uses the existing sorting and processing infrastructure as described, namely the rails and sorting stations, thereby minimizing added cost and disruption. However the invention improves efficiency by automation to minimize the number of sorts that are undertaken and to control the number of sort categories at each stage. When sorting from one to “N” at each sorting stage, the inventive idea is to automate the process such that “N” in a preliminary sort results in a population at each group for next stage sorting that is substantially equal to the number of final sorting positions. This requires automatically fixing the number of wearers in each output category of the second-last sort stage (i.e., each collection rail) so that said number is equal or nearly equal to the number of last stage sorting sites. Both the second and final stage employ computer assisted sorting for this purpose as in U.S. Pat. No. 5,794,213, namely wherein a processor signals an operator where to put each item in turn, preferably using on a stored database associating the codes with groups (e.g., wearer identities) as the items are presented and their codes are detected.

The result is to improve the extent to which sorting facilities are used, and to reduce the time and labor associated with the sorting process. By providing a final inspection, preferably by automatically reading multi-read tags used for the RFID codes, this is accomplished while ensuring that all garments that enter the system are assembled correctly with their counterparts so that the garments collected from each wearer or customer are in fact returned to that wearer of customer.

In order to develop a target for what must be delivered in each bundle delivered to a customer is to bar code or RFID code and scan the garments early in the process of handling, for example when the garments are first obtained from the customer. A record can be kept of that transaction and a receipt can be left with the customer. Provided that a unique ID is assigned to each and every garment, preferably using an RFID tag that is affixed to each day-route-stop-wearer-item, the individual items can be managed as to location, custody and various other factors. The ID code is the datum that associates all the remaining information pertaining to that item in a computer database. Multiple items can be associated with each wearer, multiple wearers with a customer, different current locations, billing, route and deliver schedules, etc. However this basis for tracking and sorting, as established by the ID code, is also used according to the invention to optimize sorting after processing.

Collected items preferably are scanned when going on (or off) the route truck and unloaded from the truck at the plant, commingled and processed through cleaning and drying. The garments are scanned at latest when emerging from the steam tunnel or press when approaching the first sort station, as the garments enter the process of sorting from a commingled group back into bundles directed to their respective wearers.

Many laundries in the US do not want or need to scan garments at multiple points in the process of collection and processing. These laundries often assume that all garments that are collected will proceed through the cleaning, drying and steam or press steps and eventually will emerge for sorting. In that case, the initial pertinent scanning of the ID code may be immediately prior to the first stage sort. The present invention accommodates initial scanning at any point prior to commencement of the sorting process. However advantages in the planning of batches can be realized if care is taken to keep batches together in processing as discussed below. Nevertheless, an exemplary implementation of the invention as follows, assumes that the first scan at the first sort is the first time the garment is identified by the sorting system.

If the first time the sorting system identifies a garment is at the first stage sort, it is not possible to know as yet how many garments are associated with a wearer and how many wearers are associated with a route and day, etc. The system of the invention nevertheless projects that garments per wearer and plans the allocation of wearers to sorting rails by presuming that the proportions will approximate the historical records for the respective wearers.

A modeling system has been devised that presents historical data to a production manager responsible for determining what route collections are brought thru the washrooms and pressing operation as associated batches, so as to use the available sorting rails and wearer garment accumulation sites. In the industrial laundry model not all wearers turn in soiled garments at every opportunity. The modeling system presents data showing total wearers—active wearers being defined as wearers that have submitted garments in the next previous period (e.g., any time in the last several weeks to several months) and the total pieces associated with these wearers. This data is used to group routes into batches.

In a first implementation of the system, routes are unloaded, sorted into soil category (color, fabric type, etc.) into soil slings, held till the next day and then washed. These are processed on a first-in-first-out method. The decision to be made is how many routes to include in a batch based on downstream sorting capacity. One goal is to make the batches as large as possible up to the capacity of the washing machines. However the batches must be limited at the same time so as not to include so many sorting breaks as to render difficult or impossible the sorting back to individual wearer units. Thus, if one has a sorting stage that is to divide from one to “N” path, it is optimal to have exactly “N” categories to be sorted at that stage. In the conventional sorting scheme outlined above, sorting to a low level account digit assumes in a decimal system that the sorting break is one to ten. An object of the invention is to use data processing to set the breaks (to choose the value of “N”) and also to aim to cause the final sorting break to use all the sort sites provided at the final sort station, for example about two dozen sites, which is a convenient number for a computer assisted human to handle.

FIG. 2 is a flow chart showing processing steps undertaken. FIGS. 3-6 show the screen shots used. Batches at built up by the production manager from selection of routes as shown in determined by the production manager they are set as groups of routes and processed thru the washroom—finishing etc in order. Batches may be intermixed based on planned or unplanned events and in the first sorting process multiple early rails have been provided which will recycle back to the first sort to accommodate this mixing of lots. Also a late rate is provided for garments that do not make it to the batch in time an these agreements have to be integrated at assembled orders at the end of the process.

Referring to FIG. 2, a first step is to assign the routes to batches. One advantageous way to do this is at first to assign one route to each batch, and to fill in where possible with another route. This selection can be done automatically as to some objects, including the object of keeping together routes that for some reason will always be processed together, the object to have batches encompass full capacity, and to avoid having early and late items wherein part of a route bridges over two or more batches. The processing system can attempt to make a match of routes to batches while leaving open the possibility that the production manager may override presumptions as to which routes might be combined into which batches.

In the example, we see a batch called 113 that contains route 13. Day 5 routes are waiting to be assigned. In FIG. 3, The operator is setting up the batches that are to go through production on the day in question. In this case we are building Day 4 routes for Dec. 28, 2006. You can see the active wearers in each batch and the day/route that the batch is made up of. The system will preserve the order that the batches are placed in the list, so if the order of production is known it would be simpler to combine batches later if that is the order they are entered.

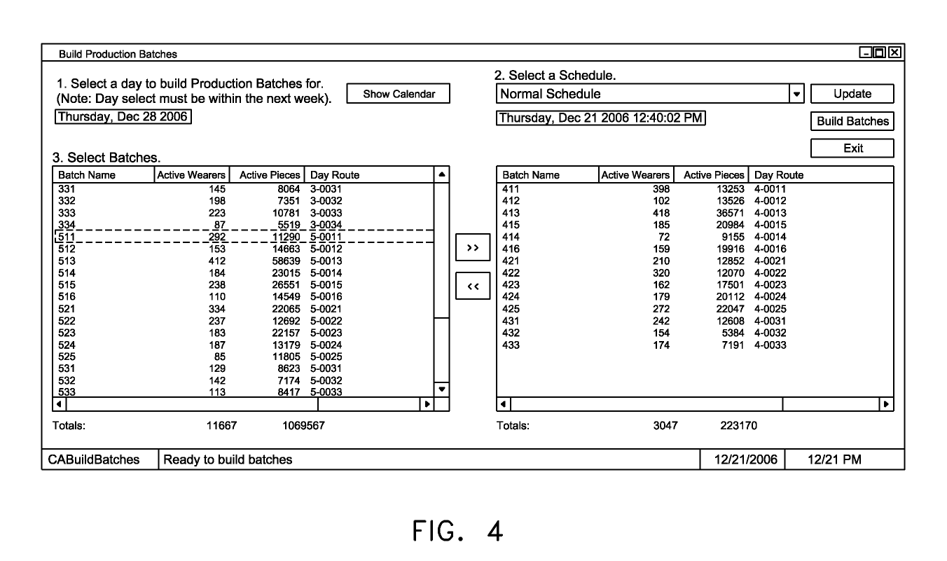

FIG. 4 the batches that were created are now grouped together as a sorting group. The system calculates the estimated number of wearers that the selected groups are expected to create. This number should be at or near the capacity of the final sort rails (e.g., two dozen for example). The rails should preferably contain garments only for the number of wearers equal to the number of final sort sites, shown as hooks in FIG. 7.

At times, an operator may decide to limit the number of sort rails used, because the production load is light. The number of rails is adjustable from two (or even only one) up to the maximum number of presort rails available to be used. However, the object is to set up the sort stages so that the final sort is substantially equal to the number of final sort sites. In the example, we see that there are a potential of 26 wearers per lot. If this is within the range of the final sort bay, we assign it. This locks these two routes together as a production batch that will be sorted as one unit.

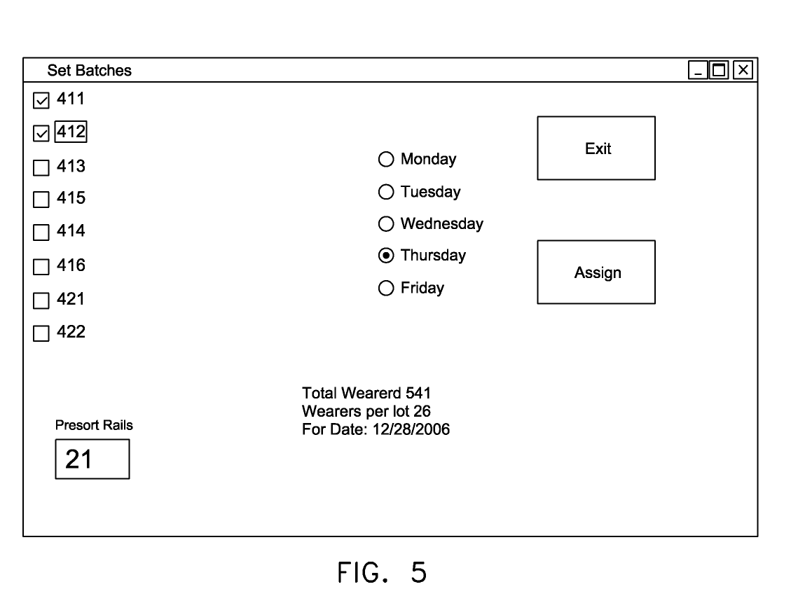

Once the batches are set for the day, presort is ready to go. Referring to FIG. 5, the operator selects the batch that will be worked from the list on the screen and sorts through the batch. The system automatically can spread out the items through the available presort rails. In addition to using the sorting site capacity, priority can be accorded to wearers that have recent history of returned garments (e.g., by assigning them to the most central and easily reached sort destination positions). Here we see several days and routes to select from, the day is the first column the routes that are in the batch are in the following columns.

The foregoing steps are illustrated schematically in FIG. 7.

In a first implementation of the system two 24-position conventional sort hook conveyors were employed. Twenty of the 24 hooks were used for sorting as described above. Two hooks were dedicated specifically to garments that arrive early and need to be held over. One hook was dedicated specifically to wearers that have canceled their contracts such that the cleaned garments can be reworked and sent into stockroom storage. One hook was dedicated to garments that have to integrated downstream, for example having become “late” due to extraction from processing for repairs.

A separate trolley also can be designated optionally as a 25^{th} to accumulate “problem” garments. The problems may relate to garments that lack readable RFID tags or have emerged far out of sequence such as garments intended for a wrong day etc.

The invention takes the anticipated wearers in a lot and spreads the garments equally on the remaining 20 rails. The second and final sort in this implementation is also a 24 sort target number of wearers for optimally efficient use of the same number of ultimate sort sites.

Preferably, the number of wearers on any one of the 24 rails should not exceed 24. Usually the target established in formatting the batches is set for a slight lower number such as 18 wearers, so that when a wearer arises in a route or lot that was not in the history file used for planning, there is room for that wearer's garments on the rails. The balancing act is to fill the 20 remaining rails with as close to 24 wearers as possible without exceeding that number.

All these decisions are done in the modeling system based on assumptions and probability. It may happen on occasion that the target number of 24 wearers is exceeded. A failsafe technique has been devised. When the second stage 24 sort is done and results in more than 24 wearers, the garments of two (or more) wearers are routed to the same destination sort site. The sorting operator is alerted to this by a thermal printed tag that is printed for attachment to the multiple-wearer garments or garment site. The tag signals a downstream employee to expect two wearers to be intermingled so unit can be extracted and manually separated. This failsafe can optionally double all 24 positions to 48 wearers (or more if necessary). But such as situation is to be avoided because it creates unnecessary downstream labor.

Another variable in the modeling system is the number of presort rails. It is the goal to have as close to 24 wearers per rail as possible at the end of the first stage sort. If the wearer count on a rail is less than the number of final sort sites (e.g., hooks), the efficiency of the second sort is reduced because capacity goes unused and there is a delay and overhead associated with cycling from one sorting event to the next. This delay includes the need to clear garments off the second sort sites, which is a batch of up to 24 wearers. This can take from 1 to 2 minutes to clear, and even if facilitated by motorized hook conveyors and the like results in some loss of time efficiency when the sites are not all used.

A small batch may be created in the modeling system, and in that case, it is optimal to operate the system so as to load fewer rails than actually are available, so that the final sort sites are substantially all used. For example, if 20 presort rails are available to accumulate groups of wearers in the first stage but there are only 240 wearers encountered in the batch, the system might put 12 wearers on a rail. But it is more efficient to reduce the number of rails used and to provide 24 wearers per rail to exploit the full efficiency of final stage sort capabilities. The system automatically assigns the wearers only to the ten closest or otherwise highest priority rails, leaving the remaining ten presort rails empty but causing the ten priority rails to hold 24 wearers each.

In a conventional manual system, there are usually three sorts required an a good deal more manpower than in the managed computer-assisted sorting method described herein. The invention brings through batches that are tailored to minimize sorting and handled efficiently to require only two stages of sort. The software breaks the batch into an efficient order for delivery so the final assembled garments are in day-route-delivery sequence-wearer order. This is done by splitting the batch into electronic lots of (for example) or up to 20 wearers on the first sort. The first rail can be assigned to the first 20 wearers, which are likely to contain wearers for a same account (e.g., route and customer stop).

Such an account might extend to the second rail where a second account is also placed. The second and final sort will works out the exact proper order. This is done as in U.S. Pat. No. 5,794,213 by reading the garment ID code and referencing stored data that ties the garment to its wearer, batch, route, stop, etc. The system operates a light or other signal at the sort destination, or reads out an audibly pronounced number or displays a number on a display screen or similarly dictates the required sorting destination to the sorting operator. In some embodiments, the system can also signal to the sorting operator when all the items expected for a wearer's order have arrived, in which case the bundle can be shifted to open that destination for accumulating the garments of a different wearer.

In one embodiment, the second sort facility comprises a given number of hooks such as 24 hooks at different elevations that feed to rails. These rails are usually short and have air stops. When up to twenty four wearers are introduced in a group, the sorting process sorts the mixed wearers so that first wearer's garments drop onto rail one—the second on rail two, etc. When the given number of wearers (e.g., up to 24) have been sorted, an air stop is released and the wearers' sorted garments drop to a second air stop. In turn, that air stop is released, feeding the garments onto a take-away conveyor. The cycle of removal takes time, but once the group is finished and the first air stop is released, sorting of a further groups can commence. Thus sorting proceeds efficiently and substantially continuously. At the end of the process the orders emerge in the order they are needed for delivery by the route to the customer.

In one embodiment, the sorting operators on each of the first and second sorts are given voice commands that state which hooks, rails or other distinct paths shall receive a garment that was just presented and scanned for an ID code. The scanning occurs when an RFID tag that is attached to or sewn into the garment is passed before a reader. The voice commands can be emitted in such language and at a pace selected by or for the sorting operator. A visual display of hook numbers is provided on a touch screen as a back up to read out the stated destination, such as a hook or rail number. This technique obviates the need to look at each garment label and then to look at the hooks when determining what hook to use. It is much faster and easier for employees to react to the stated hook number or light or other signal while handling one hanger or the like after another.

Instead of a conventional three sort process, the invention accomplishes sorts in two stages while improving efficiency at the same time. This is possible by use of software to define electronic lots, preferably automatically but allowing for override by the production manager. In an example, 20 rails may be provided for first stage sorts, and 24 final sort sites, such that the aim is for 24 wearers per rail. A typical lot might average six garments per wearer. A typical lot size might be up to 2400 garments to be processed. Lots can be overlapped because of the provision for early rails, although early/late items have the adverse aspect that the early/late edges of lots may have to be handled twice, but only during the first sort.

The early/late items are members of “fuzzy” lots because their edges overlap batches. However such lots preferably are identified in the software, which helps in lot control processing. If lots come across out of order, the software at the first sort can change the lot order based on such occurrence.

The net of the sorting techniques is that a conventional hook conveyor sorting system can be enhanced to reduce the sorting labor by up to 50% without major modifications to the layout of a plant that formerly sorted entirely manually. In addition to efficiency, accuracy is improved with this automation. Preferably, a final check out station is provided to scan the ID tags in each final customer bundle after the final sort has been accomplished. Therefore, even if during the sorting process, the operator should fail to put a garment on the correct hook (“human error”), the system can recover. The second stage sort program catches mistakes made during the first sort and alerts the operator. Any mistakes made during the second sort are caught by the final scan out station.

At the final scan out station, the garments could be read one at a time. Preferably, the RFID tags and readers are of the type adapted for multi-reading, i.e., wherein the RFID tags in range of an antenna are polled to discern their ID codes. This can be done by using a standard antenna—a wand or a bundle reader. The scan data is compared to the data on the garments as originally introduced into the system, preferably at the earliest scan at the customer site or delivery truck or soil bag or soil department or finishing department. The referenced data can be collected as late as the first scan and still provides data that is useful for correcting sorting mistakes. The goal is that what comes into the process leaved the process. If for any reason, the garment tags scanned do not match the expected inventory items, a thermal ticket is produced. The thermal ticket is applied to the bundle to point out the problem so it can be corrected. The ticket advantageously can identify the last place the items were scanned, e.g., upon the first sort or during repair, etc. This information can also be obtained by inquiring via the inventory control processor.

The foregoing embodiments provide for increased accuracy—reduced labor—and improved customer satisfaction, compared to the alternative of manual sorting. RFID is a significant part of the system do to the ease and speed of reading the tag ID during the process and the use of the optional multi-read process. The system carries little plant disruption apart from the installation of scanners and enunciators to read out the stated destination for first and second sorting stage steps. Although human sorting steps are involved, and labor is often costly, the disclosed system actually is cost effective over totally automated sorting systems with computer actuated conveyor diverting device and the like, when on considers all the associated costs of floor space, installation, maintenance and depreciation. The minimally invasive addition of computing equipment, RFID scanners and sorting direction readouts and enunciators have a return on investment that is much faster than total automation together with much less aggravation and equipment associated cost.

The invention having been disclosed, a number of alternatives within the scope of the invention will occur to persons skilled in the art. This disclosure is not limited to the specific embodiments discussed and should be construed as to encompass general, specific and equivalent variations of the devices and systems as described.

What is claimed is:

1. A method for assembling items into associated groups, comprising:
providing a plurality of preliminary sort locations for a preliminary sorting stage and a plurality of subsequent sort locations for a subsequent sorting stage;
providing on each item to be processed a code adapted for automatic data capture, and maintaining a data memory for cross referencing at least an item identification code and an associated group identity for each of a plurality of items to be processed at one time;
wherein the plurality of items to be processed are commingled and are to be sorted into the associated groups;
providing a programmed processor coupled to the data memory and to a code reader, and reading from the code reader the item identification code of successive ones of the plurality of items when presented for sorting;
determining from the data memory the associated group identity of the item presented for sorting;
determining via the processor and signaling to a human, an assigned one of the preliminary sort locations for accumulating items having a same associated group identity as that of the item presented for sorting;
continuing to present successive ones of the plurality of items for sorting, determining the corresponding group identity, signaling the human and accumulating the items at the preliminary sort locations;
wherein a number of associated group identities that are assigned to each of the preliminary sort locations is controlled relative to a number of associated group identities assigned to the subsequent sort locations;
after at least substantially moving the presented items to the preliminary sort locations, sorting items for each of the preliminary sort locations into the subsequent sort locations.

2. The method of claim 1, wherein the items are collected from a plurality of routes and are sorted for return to the same said routes, and further comprising assigning the group identities to the preliminary sorting locations at least partly to bring the items from respective ones of the routes into proximity at least at the preliminary sorting locations.

3. The method of claim 1, wherein the items are collected from a plurality of entities on a plurality of routes, for return to the same said entities, and further comprising assigning the group identified to the preliminary sorting locations at least partly to bring the items from respective ones of the entities into proximity at least at the subsequent sorting locations.

4. The method of claim 1, wherein at least the subsequent sorting locations are provided in a fixed number, and further comprising accumulating at least at predetermined ones of the preliminary sorting locations a number of associated group identities that is substantially equal to the fixed number.

5. The method of claim 4, wherein at least the subsequent sorting locations are provided in a fixed number, and further comprising accumulating at least at predetermined ones of said preliminary sorting locations a number of associated group identities that is substantially equal to the fixed number, less at least one location that is reserved for reserved group identities.

6. The method of claim 5, wherein the group identities comprise at least one of items presented before or after a main body of items having an associated group identity, and items processed out of turn.

7. The method of claim 4, wherein the number of subsequent sorting locations is less than or equal to 24.

8. The method of claim 6, wherein the number of preliminary sorting locations comprises a variable number of active sorting locations selected by the processor to aim for each of the active sorting locations to hold a number of associated groups that is less than or equal to a number of subsequent sorting locations.

9. The method of claim 8, further comprising maintaining historical data via the processor, for the associated groups, and wherein the processor is programmed to predict a number of sorting locations for at least one of the preliminary and subsequent sorting locations, based on a portion of the historical data related to at least one of said associated groups when items of the respective one of the associated groups are presented for sorting.

10. The method of claim 1, wherein the associated groups comprise at least one of collection routes, customer locations along the collections routes, entities encompassed by customer locations, product types, product processing types, and pickup/delivery schedules.

11. The method of claim 1, further comprising obtaining a record of items intended for inclusion in at least some of the associated groups and further comprising comparing identities of items in the associated groups with the record after said sorting.

12. The method of claim 11, wherein the identities of the items in said associated groups after scanning are determined by reading multi-read RFID tags affixed to items in the associated groups.

13. The method of claim 12, wherein the record of items is based at least partly on a preliminary scanning of RFID tags affixed to items at a point in processing preceding said sorting.

14. An apparatus for assembling items into associated groups, comprising:
a plurality of items, each bearing a code indicia adapted for automatic data capture;
a data processor coupled to a reader for detecting said code indicia on an item presented for sorting, and to a data memory for cross referencing at least an item identification code and an associated group identity for each of a plurality of items to be processed at one time;
at least two successively staged sort areas, each having plural item collection areas, and at least one readout device coupled to an output of the data processor, providing an output that identifies one of the item collection areas, for indicating to a human operator an item collection area where a detected item is to be placed;
wherein the processor is programmed to determine from the data memory the associated group identity of the item presented for sorting and to identify via the output an assigned one of the preliminary sort locations for accumulating items having a same associated group identity as that of the item presented for sorting;
wherein a number of associated group identities that are assigned to each of the preliminary sort locations is controlled by the processor relative to a number of associated group identities assigned to the subsequent sort locations; and,
wherein the processor is operable using the human operator to place the items, to load the preliminary sort locations with items in a limited number of associated groups, and to sort the associated groups to the subsequent sort locations.

15. The apparatus of claim 14, wherein at least the subsequent sorting locations are provided in a fixed number, and wherein the processor is operable to deploy a variable number of the preliminary sorting locations.

16. The apparatus of claim 14, wherein at least the subsequent sorting locations are provided in a fixed number, and the processor is operable to deploy a variable number of the preliminary sorting locations such that a number of associated group identities at least at one of the preliminary sorting locations is caused to correspond substantially with a number of available subsequent sort locations.

17. The apparatus of claim 14, wherein at least the subsequent sorting locations are provided in a fixed number, and the processor is operable to deploy a variable number of the preliminary sorting locations such that a number of associated group identities at least at one of the preliminary sorting locations is caused to correspond with a number of available subsequent sort locations while reserving at least one said preliminary sorting location for at least one of items presented before or after a main body of items having an associated group identity, and items processed out of turn.

18. The apparatus of claim 14, wherein the number of subsequent sorting locations is less than or equal to 24.

19. The apparatus of claim 14, wherein the data memory is loaded with identities of items correctly associated with said items after sorting, further comprising a multi-read scanner coupled to the processor, and wherein the processor is operable to compare said identities with identities found by scanning the items.
